(19) United States
(12) Patent Application Publication
(10) Pub. No.: US 2026/0214707 A1
(43) Pub. Date: Jul. 23, 2026

(54) METHOD AND DEVICE FOR CHANGING LINK IN WIRELESS LAN SUPPORTING EMLSR

(71) Applicant: ELECTRONICS AND TELECOMMUNICATIONS RESEARCH INSTITUTE, Daejeon (KR)

(72) Inventors: Sung Hyun HWANG, Daejeon (KR); Kyu Min KANG, Daejeon (KR); Yong Ho KIM, Incheon (KR); Ju Seong MOON, Osan-si, Gyeonggi-do (KR)

(21) Appl. No.: 18/995,759

(22) PCT Filed: Aug. 7, 2023
(86) PCT No.: PCT/KR2023/011600

§ 371 Date: Jan. 16, 2025

(30) Foreign Application Priority Data
Aug. 8, 2022 (KR) 10-2022-0098739
Mar. 2, 2023 (KR) 10-2023-0028108
May 4, 2023 (KR) 10-2023-0058661
Jul. 18, 2023 (KR) 10-2023-0093230

(51) Int. Cl. H04W 74/0816; H04W 74/00

(52) U.S. Cl. CPC H04W 74/0816; H04W 74/002

(57) ABSTRACT

A method and a device for changing a link in a wireless LAN supporting EMLSR are disclosed. A method of a first device comprises the steps of: on a first link among multiple links, receiving, from a second device, a first frame including first information indicating discontinuation of using the first link; and performing first communication with the second device on a second link, for which discontinuation of use is not indicated by the first frame, among the multiple links.

### TECHNICAL FIELD

The present disclosure relates to a wireless local area network (LAN) communication technique, and more particularly, to a technique for (re) configuration of a link for multi-link operations of an enhanced multi-link single radio (EMLSR) device.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multi-access point (AP) transmission operations, and/or efficient retransmission operations (e.g., hybrid automatic repeat request (HARQ) operations).

However, since a multi-link operation is an operation not defined in the existing wireless LAN standard, it may be required to define detailed operations according to an environment in which the multi-link operation is performed. In particular, a device (e.g., station (STA)) supporting enhanced multi-link single radio (EMLSR) operations may wait for reception in a multi-link. The device supporting EMLSR operations may be referred to as an EMLSR device.

When an EMLSR device starts transmitting and receiving frame(s) on a single link, the EMLSR device may operate only on the single link. In other words, the EMLSR device cannot transmit/receive frame(s) in other links while performing frame transmission/reception on the single link. A time may be required for the EMLSR device to switch a transceiver between links. Therefore, multi-link data transmission/reception methods considering the single link operating characteristics of the EMLSR device may be required. In addition, link change methods and/or link (re) configuration methods may be required for multi-link operations of the EMLSR device.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for changing and/or (re) configuring link(s) for an EMLSR device.

### Technical Solution

A method of a first device, according to a first exemplary embodiment of the present disclosure for achieving the above-described objective, may comprise: receiving, from a second device, a first frame including first information indicating stop of using a first link of a multi-link on the first link; and performing first communication with the second device on a second link of the multi-link, the second link being a link whose use is not indicated to be stopped by the first frame, wherein second communication between the first device and the second device is not performed on the first link whose use is indicated to be stopped by the first frame.

The first frame may further include second information indicating a time at which use of the first link is stopped, the first communication between the first device and the second device link may be performed on the second link from the time, and the first link may not be used from the time.

The first information may be traffic identifier (TID)-to-link mapping information, and there may be no TID mapped to the first link in the TID-to-link mapping information.

The performing of the first communication with the second device may comprise: receiving a data frame from the second device on the second link without receiving an initial control frame of the second device; and transmitting a response frame for the data frame to the second device on the second link.

When the first device supports an enhanced multi-link single radio (EMLSR) operation, the first link and the second link are EMLSR links, and only one link among the EMLSR links is available according to indication of the first frame, the EMLSR operation of the first device may be stopped.

The first frame may be a beacon frame or an extreme high throughput (EHT) action frame.

The first device may be a station (STA) multi-link device (MLD), the first device may include a first STA operating on the first link and a second STA operating on the second link, the second device may be an access point (AP) MLD, and the second device may include a first AP operating on the first link and a second AP operating on the second link.

A method of a first device, according to a second exemplary embodiment of the present disclosure for achieving the above-described objective, may comprise: receiving, from a second device, a first frame including first information indicating stop of using a first link of a multi-link on the first link; and performing a listening operation on a second link and a third link of the multi-link, the second link and the third link being links whose uses are not indicated to be stopped by the first frame, wherein communication between the first device and the second device is not performed on the first link whose use is indicated to be stopped by the first frame.

The first frame may further include second information indicating a time at which use of the first link is stopped, and the first link may not be used from the time.

Enhanced multi-link single radio (EMLSR) links before the time may include the first link, the second link, and the third link, the EMLSR links after the time may include the second link and the third link, and the EMLSR links may be reconfigured based on the first frame.

The first information may be traffic identifier (TID)-to-link mapping information, and there may be no TID mapped to the first link in the TID-to-link mapping information.

The method may further comprise: receiving an initial control frame from the second device on one link among the second link and the third link; and after receiving the initial control frame, receiving a data frame from the second device on the one link.

The first device may be a station (STA) multi-link device (MLD), the first device may include a first STA operating on the first link, a second STA operating on the second link, and a third STA operating on the third link, the second device may be an access point (AP) MLD, and the second device may include a first AP operating on the first link, a second AP operating on the second link, and a third AP operating on the third link.

A method of a second device, according to a third exemplary embodiment of the present disclosure for achieving the above-described objective, may comprise: generating a first frame including first information indicating stop of using a first link of a multi-link; transmitting the first frame to a first device on the first link; and performing first communication with the first device on a second link of the multi-link, the second link being a link whose use is not indicated to be stopped by the first frame, wherein second communication between the first device and the second device is not performed on the first link whose use is indicated to be stopped by the first frame.

The performing of the first communication with the first device may comprise, when the second device does not perform an enhanced multi-link single radio (EMLSR) operation, transmitting a data frame to the first device without transmitting an initial control frame on the second link.

The performing of the first communication with the first device may comprise: when the second device performs an EMLSR operation, transmitting an initial control frame to the first device on the second link; and after transmitting the initial control frame, transmitting a data frame to the first device on the second link.

The first information may be traffic identifier (TID)-to-link mapping information, and there may be no TID mapped to the first link in the TID-to-link mapping information.

When the first device supports an enhanced multi-link single radio (EMLSR) operation, the first link and the second link are EMLSR links, and only one link among the EMLSR links is available according to indication of the first frame, the EMLSR operation of the first device may be stopped.

The first frame may further include second information indicating a time at which use of the first link is stopped, and the first link may not be used from the time.

Enhanced multi-link single radio (EMLSR) links before the time may include the first link, the second link, and the third link, the EMLSR links after the time may include the second link and the third link, and the EMLSR links may be reconfigured based on the first frame.

### Advantageous Effects

According to the present disclosure, an EMLSR device may wait for reception of a frame (e.g., data frame) on as many links as the number of antennas. When a frame is received on a first link, the EMLSR device may switch radio chain(s) to the first link on which the frame is received and quickly receive the frame over a plurality of spatial streams on the first link. Operations of the EMLSR device may be changed by an AP. The operations of the EMLSR device may be changed depending on an operation of an AP and/or STA. Accordingly, the EMLSR device can perform smooth communication.

### DESCRIPTION OF DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating an association procedure of a station in a wireless LAN system.

FIG. 5 is a timing diagram illustrating a first exemplary embodiment of an operation method of a communication node based on EDCA.

FIG. 6 is a block diagram illustrating a first exemplary embodiment of an enhanced multi-link single radio (EMLSR) device in a wireless LAN.

FIG. 7A is a timing diagram illustrating a first exemplary embodiment of a link change method for an EMLSR device in a wireless LAN supporting multiple links.

FIG. 7B is a timing diagram illustrating a second exemplary embodiment of a link change method for an EMLSR device in a wireless LAN supporting multiple links.

FIG. 8A is a timing diagram illustrating a third exemplary embodiment of a link change method for an EMLSR device in a wireless LAN supporting multiple links.

FIG. 8B is a timing diagram illustrating a fourth exemplary embodiment of a link change method for an EMLSR device in a wireless LAN supporting multiple links.

FIG. 9 is a timing diagram illustrating a first exemplary embodiment of a link change method in a wireless LAN supporting multiple links.

FIG. 10 is a timing diagram illustrating a fifth exemplary embodiment of a link change method in a wireless LAN supporting multiple links.

FIG. 11 is a timing diagram illustrating a sixth exemplary embodiment of a link change method in a wireless LAN supporting multiple links.

FIG. 12 is a block diagram illustrating a first exemplary embodiment of a control field format for EMLSR configuration between AP MLD and STA MLD.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

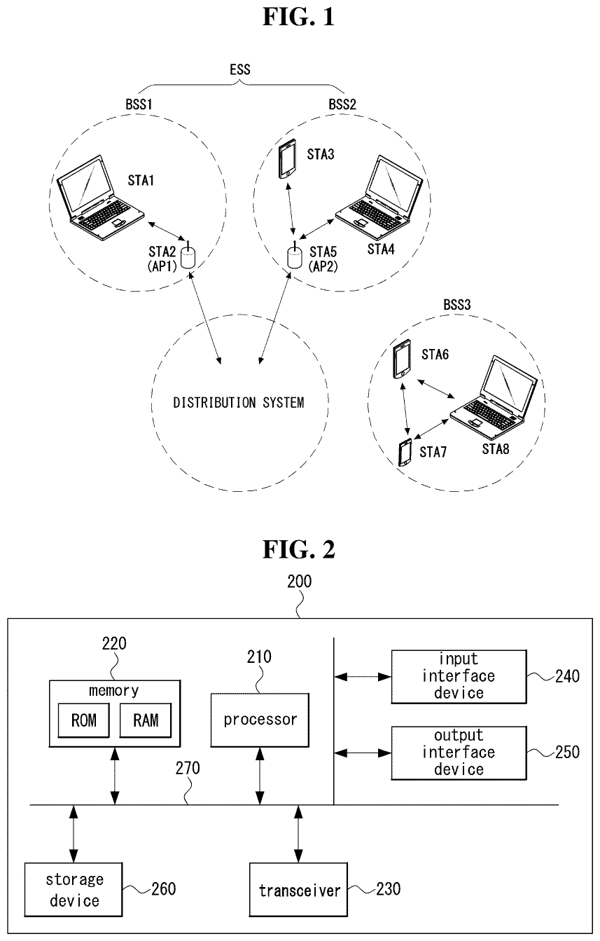

FIG. 1 is a conceptual diagram illustrating a first exemplary embodiment of a wireless LAN system.

Referring to FIG. 1, a wireless LAN system may include at least one basic service set (BSS). A BSS may refer to a set of stations (e.g., STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (AP1) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (AP1) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (AP1), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

FIG. 2 is a block diagram illustrating a first exemplary embodiment of a communication node constituting a wireless LAN system.

Referring to FIG. 2, a communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

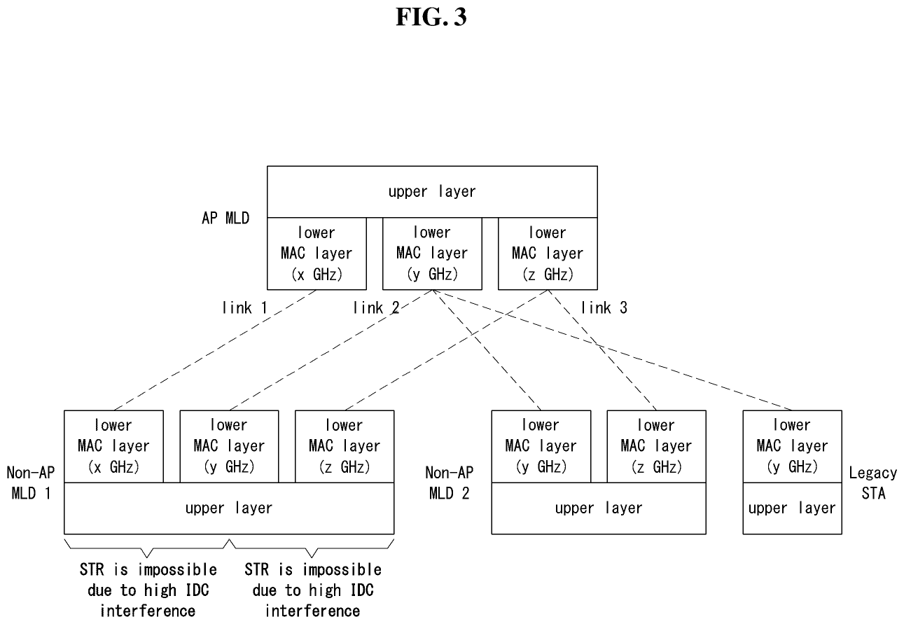

FIG. 3 is a conceptual diagram illustrating a first exemplary embodiment of a multi-link configured between multi-link devices (MLDs).

Referring to FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD). The AP of the AP MLD may mean an AP affiliated with the AP MLD. The STA of the STA MLD may mean a STA affiliated with the STA MLD.

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

Each of the AP MLD and the STA MLD may have an MLD MAC address, and each of the AP and the STA operating in each link may have a MAC address. The MLD MAC address of the AP MLD may be referred to as an AP MLD MAC address, and the MLD MAC address of the STA MLD may be referred to as a STA MLD MAC address. The MAC address of the AP may be referred to as an AP MAC address, and the MAC address of the STA may be referred to as a STA MAC address. In a multi-link negotiation procedure, the AP MLD MAC address and the STA MLD MAC address may be used. The address of the AP and the address of the STA may be exchanged and/or configured in the multi-link negotiation procedure.

When the multi-link negotiation procedure is completed, the AP MLD may generate an address table and manage and/or update the address table. One AP MLD MAC address may be mapped to one or more AP MAC addresses, and corresponding mapping information may be included in the address table. One STA MLD MAC address may be mapped to one or more STA MAC addresses, and corresponding mapping information may be included in the address table. The AP MLD may identify address information based on the address table. For example, when a STA MLD MAC address is received, the AP MLD may identify one or more STA MAC addresses mapped to the STA MLD MAC address based on the address table.

In addition, the STA MLD may manage and/or update the address table. The address table may include ‘mapping information between the AP MLD MAC address and the AP MAC address(es)’ and/or ‘mapping information between the STA MLD MAC address and the STA MAC address(es)’. The AP MLD may receive a packet from a network, identify an address of a STA MLD included in the packet, identify link(s) supported by the STA MLD, and may identify STA(s) taking charge of the link(s) from the address table. The AP MLD may set STA MAC address(es) of the identified STA(s) as receiver address(es), and may generate and transmit frame(s) including the receiver address(es).

Meanwhile, an association procedure in a wireless LAN system may be performed as follows.

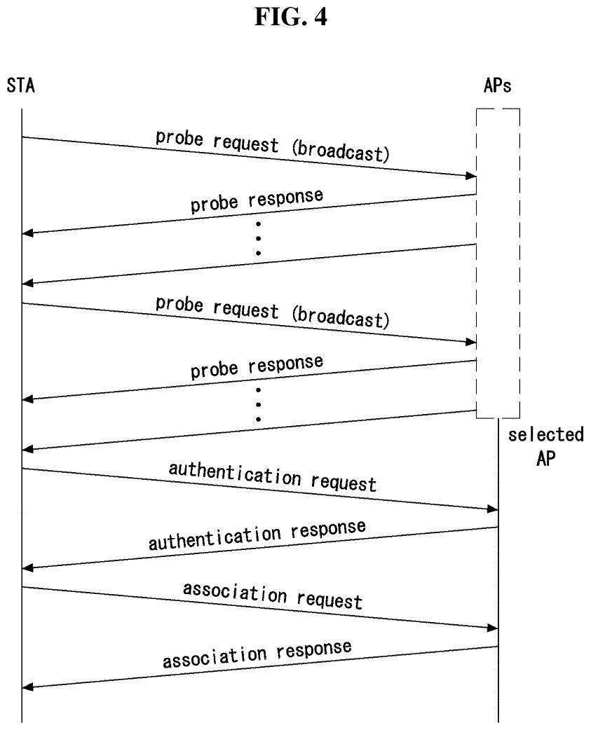

FIG. 4 is a sequence chart illustrating an association procedure of a station in a wireless LAN system.

Referring to FIG. 4, an association procedure of a STA in an infrastructure BSS may generally be divided into a probe step of detecting AP(s), an authentication step with detected AP(s), and an association step with the authenticated AP(s). The STA may be a STA MLD or a STA affiliated with the STA MLD, and the AP may be an AP MLD or an AP affiliated with the AP MLD.

The STA may detect neighboring APs using a passive scanning scheme or an active scanning scheme. When the passive scanning scheme is used, the STA may detect neighboring APs by overhearing beacons transmitted by APs. When the active scanning scheme is used, the STA may transmit a probe request frame, and may detect neighboring APs by receiving probe response frames that are responses to the probe request frame from the APs.

When the neighboring APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In this case, the STA may select one AP among AP(s) with which the STA has performed the authentication step, and perform the association step with the selected AP. That is, the STA may transmit an association request frame to the selected AP, and may complete the association with the selected AP by receiving an association response frame that is a response to the association request frame from the selected AP.

Meanwhile, communication nodes (e.g., access points, stations, and the like) belonging to the wireless LAN system may perform transmission and reception operations of frames based on a point coordination function (PCF), hybrid coordination function (HCF), HCF controlled channel access (HCCA), distributed coordination function (DCF), enhanced distributed channel access (EDCA), and/or the like.

In the wireless LAN system, frames may be classified into a management frame, a control frame, and a data frame. The management frame may include an association request frame, association response frame, reassociation request frame, reassociation response frame, probe request frame, probe response frame, beacon frame, disassociation frame, authentication frame, deauthentication frame, action frame, and the like.

The control frame may include an acknowledgment (ACK) frame, block ACK request (BAR) frame, block ACK (BA) frame, power saving (PS)-Poll frame, request-to-send (RTS) frame, clear-to-send (CTS) frame, and the like. The data frame may be classified into a quality of service (QOS) data frame and a non-QoS data frame. The QoS data frame may refer to a data frame for which transmission according to a QoS is required, and the non-QoS data frame may indicate a data frame for which transmission according to a QoS is not required. The QoS data frame may include a QoS Null frame, and the QoS Null frame may not include a payload.

Meanwhile, in a wireless LAN system, a communication node (e.g., access point or station) may operate based on the EDCA scheme.

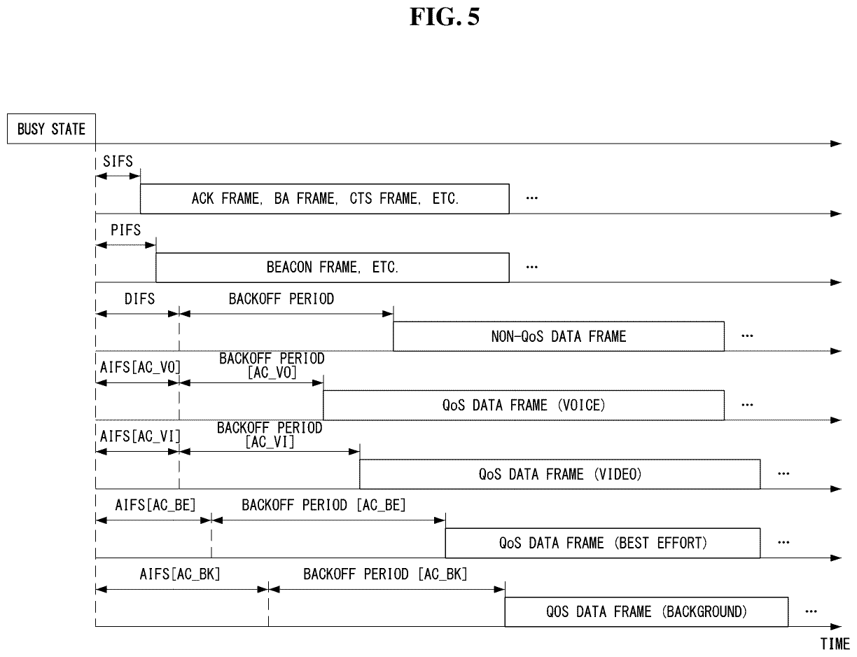

FIG. 5 is a timing diagram illustrating a first exemplary embodiment of an operation method of a communication node based on EDCA.

Referring to FIG. 5, a communication node desiring to transmit a control frame (or a management frame) may perform a channel state monitoring operation (e.g., carrier sensing operation) during a predetermined period (e.g., short interframe space (SIFS) or PCF IFS (PIFS)), and when the channel state is determined to be idle during the predetermined period (e.g., SIFS or PIFS), the communication node may transmit the control frame (or the management frame). For example, the communication node may transmit an ACK frame, a BA frame, a CTS frame, or the like when the channel state is determined to be idle during SIFS. Also, the communication node may transmit a beacon frame or the like when the channel state is determined to be idle during the PIFS. On the other hand, when it is determined that the channel state is busy during the predetermined period (e.g., SIFS or PIFS), the communication node may not transmit the control frame (or the management frame). Here, the carrier sensing operation may refer to a clear channel assessment (CCA) operation.

A communication node desiring to transmit a non-QoS data frame may perform a channel state monitoring operation (e.g., carrier sensing operation) during DCF IFS (DIFS), and when the channel state is determined to be idle during the DIFS, the communication node may perform a random backoff procedure. For example, the communication node may select a backoff value (e.g., a backoff counter) within a contention window according to the random backoff procedure and may perform a channel state monitoring operation (e.g., carrier sensing operation) during a period corresponding to the selected backoff value (hereinafter, referred to as ‘backoff period’). The communication node may transmit the non-QoS data frame when the channel state is determined to be idle in the backoff period.

A communication node desiring to transmit a QoS data frame may perform a channel state monitoring operation (e.g., carrier sensing operation) during an arbitration IFS (AIFS), and when the channel state is determined to be idle during the AIFS, the communication node may perform a random backoff procedure. The AIFS may be configured according to an access category (AC) of a data unit (e.g., protocol data unit (PDU)) included in the QoS data frame. The AC of the data unit may be as shown in Table 1 below.

TABLE 1

| Priority | AC | Description |
|---|---|---|
| Lowest | AC_BK | Background |
| | AC_BE | Best effort |
| | AC_VI | Video |
| Highest | AC_VO | Voice |

AC_BK may indicate background data, AC_BE may indicate data transmitted in the best effort manner, AC_VI may indicate video data, AC_VO may indicate voice data. For example, the length of the AIFS for the QoS data frame corresponding to each of AC_VO and AC_VI may be configured to be equal to the length of the DIFS. The length of the AIFS for the QoS data frame corresponding to each of AC_BE and AC_BK may be configured to be longer than the length of the DIFS. Here, the length of the AIFS for the QoS data frame corresponding to AC_BK may be configured to be longer than the length of the AIFS for the QoS data frame corresponding to AC_BE.

In the random backoff procedure, the communication node may select a backoff value (e.g., a backoff counter) within a contention window according to the AC of the QoS data frame. The contention window according to the AC may be as shown in Table 2 below. CWₘᵢₙ may indicate a minimum value of the contention window, CWₘₐₓ may indicate a maximum value of the contention window, and each of the minimum value and the maximum value of the contention window may be represented by the number of slots.

TABLE 2

| AC | CWₘᵢₙ | CWₘₐₓ |
|---|---|---|
| AC_BK | 31 | 1023 |
| AC_BE | 31 | 1023 |
| AC_VI | 15 | 31 |
| AC_VO | 7 | 15 |

The communication node may perform a channel state monitoring operation (e.g., carrier sensing operation) in the backoff period and may transmit the QoS data frame when the channel state is determined to be idle in the backoff period.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP. In exemplary embodiments, operations of a STA may be interpreted as operations of a STA MLD, operations of a STA MLD may be interpreted as operations of a STA, operations of an AP may be interpreted as operations of an AP MLD, and operations of an AP MLD may be interpreted as operations of an AP.

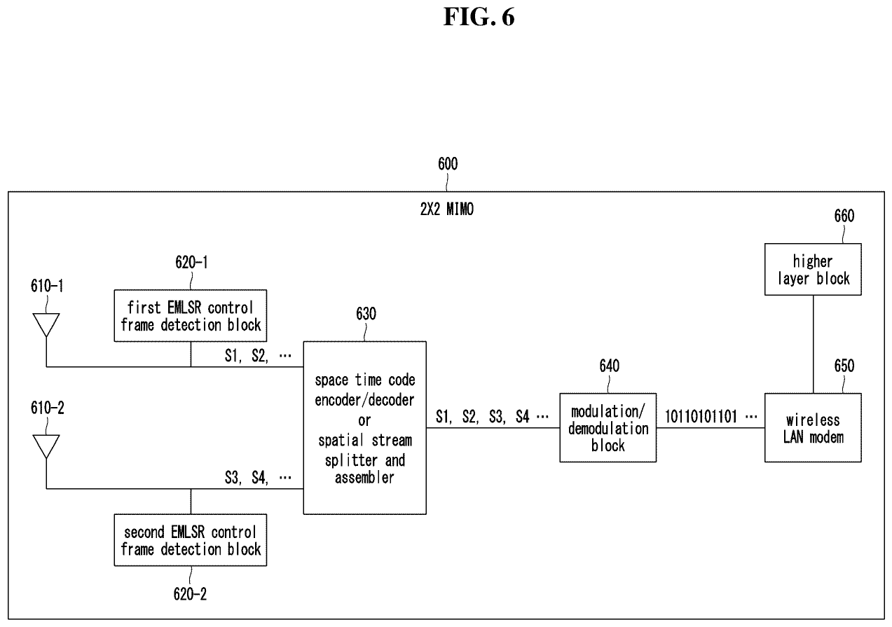

FIG. 6 is a block diagram illustrating a first exemplary embodiment of an enhanced multi-link single radio (EMLSR) device in a wireless LAN.

Referring to FIG. 6, an EMLSR device 600 may be an MLD supporting MLSR operations and/or EMLSR operations. The EMLSR device 600 may be referred to as an MLSR device. An EMLSR STA (or MLSR STA) may be a STA supporting MLSR operations and/or EMLSR operations, and an EMLSR AP (or MLSR AP) may be an AP supporting MLSR operations and/or EMLSR operations. The MLSR operation may mean an MLSR mode, and the EMLSR operation may mean an EMLSR mode. The EMLSR device 600 may include antennas 610-1 and 610-2, EMLSR control message detection blocks 620-1 and 620-2, a spatial stream processing block 630, a modulation and demodulation block 640, a wireless LAN modem 650, and/or a higher layer block 660. In exemplary embodiments, a spatial stream may be referred to as ‘SS’.

The EMLSR device 600 may include the plurality of antennas 610-1 and 610-2. The first antenna 610-1 may be used for a sensing operation and/or a reception operation of signals on a first link. The second antenna 610-2 may be used for a sensing operation and/or a reception operation of signals on a second link. A frequency at which the first link operates may be different from a frequency at which the second link operates. The sensing operation and/or reception operation performed by the first antenna and/or the second antenna may be referred to as ‘listening operation’. In order to simultaneously receive spatial stream signals, the first antenna 610-1 and the second antenna 610-2 may perform sensing operations and/or reception operations of signals on one of the first link and the second link.

Among the plurality of antennas 610-1 and 610-2 included in the EMLSR device 600, one antenna may be a primary antenna, and the remaining antenna(s) may be secondary antenna(s). The primary antenna and secondary antenna(s) may be configured in advance. Alternatively, the primary antenna and the secondary antenna(s) may be configured in a negotiation procedure between the EMLSR device 600 and another device (e.g., AP MLD supporting EMLSR operations). An antenna performing a listening operation on a link having a low number (e.g., low index) may be configured as the primary antenna, and the remaining antenna(s) may be configured as the secondary antenna(s).

The first EMLSR control frame detection block 620-1 may be connected to or cooperate with the first antenna 610-1, and the second EMLSR control frame detection block 620-2 may be connected to or cooperate with the second antenna 610-2. Electromagnetic waves (e.g., signals) detected by the antennas 610-1 and 610-2 may be input to the EMLSR control frame detection blocks 620-1 and 620-2. The EMLSR control frame detection blocks 620-1 and 620-2 may determine whether the electromagnetic wave (e.g., signal) corresponds to a specific control frame (e.g., initial control frame). The EMLSR control frame detection blocks 620-1 and 620-2 may support only a predefined modulation and coding scheme (MCS) and may identify only predefined control frame formats. The formats of the predefined control frames (e.g., specific control frame, initial control frame) may include a request-to-send (RTS) frame, a multi-user (MU)-RTS trigger frame, and/or a buffer status report poll (BSRP) trigger frame.

When a specific control frame is detected by the EMLSR control frame detection blocks 620-1 and/or 620-2, the EMLSR device 600 may perform a reception operation for receiving data through multiple SSs by simultaneously using as many spatial streams as the number of spatial streams (e.g., the number of antennas) supported by the EMLSR device 600. In order to perform the reception operation for simultaneously receiving multiple spatial streams, a clear-to-send (CTS) frame may be transmitted through the first antenna 610-1 after a short inter-frame space (SIFS) from a time of detecting the specific control frame on the first link, and the second antenna 610-2 operating on the second link on which the specific control frame is not detected, may switch to the first link and operate on the first link. In other words, a reception radio chain (i.e., RX radio chain) may be switched to operate on the first link. In the present disclosure, the RX radio chain may refer to a radio chain. In addition, in the present disclosure, the radio chain may refer to an RX radio chain or an RX chain. The radio chain may refer to a radio frequency (RF) chain. Switching of an operating link of the second antenna 610-2 (e.g., switching of the radio chain) may start after the time of detecting the specific control frame on the first link, and may be completed until a SIFS elapses after transmitting the CTS signal after a SIFS elapses. Thereafter, multiple spatial streams (e.g., two spatial streams) may be received through the plurality of antennas 610-1 and 610-2. The operation of receiving the MU-RTS trigger frame and the operation of switching the radio chain to receive multiple spatial streams may be referred to as ‘EMLSR operation’.

When a signal is received through one of the plurality of antennas 610-1 and 610-2, and the received signal is not the specific control frame detected by the EMLSR control frame detection blocks 620-1 and 620-2, the received signal may be delivered to the modulation/demodulation block 640 without going through the spatial stream processing block 630. The antenna that performs the above-described operation (e.g., the operation of delivering the received signal to the modulation/demodulation block 640) may be the primary antenna.

When the specific control frame is detected by the EMLSR control frame detection blocks 620-1 and 620-2, and the reception procedure for the multiple spatial streams is performed, the spatial stream processing block 630 may perform a rearrangement operation for signals (e.g., symbols) received through the plurality of antennas 610-1 and 610-2. When a space time code is used, a single symbol may be generated into a plurality of symbols by a coding operation, and the plurality of symbols may be transmitted. The space time code may be an Alamouti code. The spatial stream processing block 630 may perform an operation of restoring the redundant symbols into the single symbol in a decoding procedure.

The output symbols of the spatial stream processing block 630 may be input to the modulation/demodulation block 640. The modulation/demodulation block 640 may generate bits by performing a demodulation operation on the symbols. The modulation/demodulation block 640 may perform a channel coding operation and/or a channel decoding operation. The output bits of the modulation/demodulation block 640 may be delivered to the wireless LAN modem 650. The wireless LAN modem 650 may perform medium access control (MAC) operations defined in the IEEE 802.11 standards. An output of the wireless LAN modem 650 may be delivered to the higher layer block 660. The higher layer block 660 may perform higher layer operations defined in the IEEE 802.11 standards. A series of operations performed after the specific control frame is detected by the EMLSR control frame detection block may be operations performed during the EMLSR operation. In the EMLSR device 600, a transmission operation may be performed in the reverse order of the above-described reception operation. The above-described antenna may refer to an RF chain that is a transmission and reception block including the antenna. The RF chain may be a hardware or/and logical structure including both a transmission (Tx) chain and an reception (Rx) chain.

Meanwhile, an EMLSR device may refer to an EMLSR MLD, an EMLSR STA MLD, an EMLSR AP MLD, an EMLSR STA, and/or an EMLSR AP. An operation state of the EMLSR device may be classified into a listening operation state and an EMLSR operation state. Alternatively, the operation state of the EMLSR device may be classified into a listening operation state, an EMLSR operation state, and a blindness state. In the listening operation state, the EMLSR STA may perform a reception operation for frame(s) (e.g., initial control frame) on EMLSR links. In the EMLSR operation state, the EMLSR STA may transmit and receive frames on a single link. The single link may be one of the EMLSR links. The EMLSR operation state may refer to a normal state, a normal operation state, a normal transmission state, a normal reception state, and/or a normal transmission/reception state. A period in the blindness state may be referred to as ‘blindness period’. In the present disclosure, a transmission time may mean a transmission start time and/or a transmission end time, and a reception time may mean a reception start time and/or a reception end time.

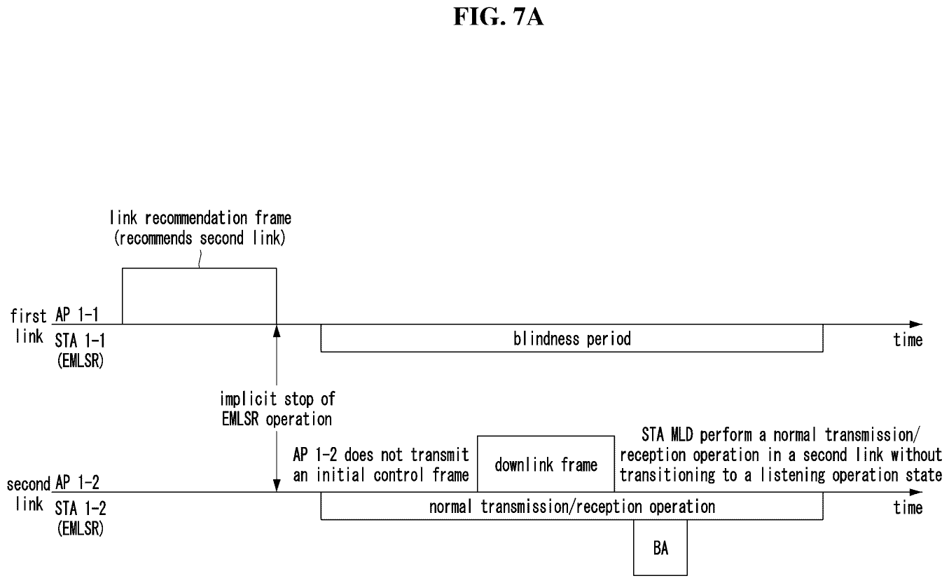

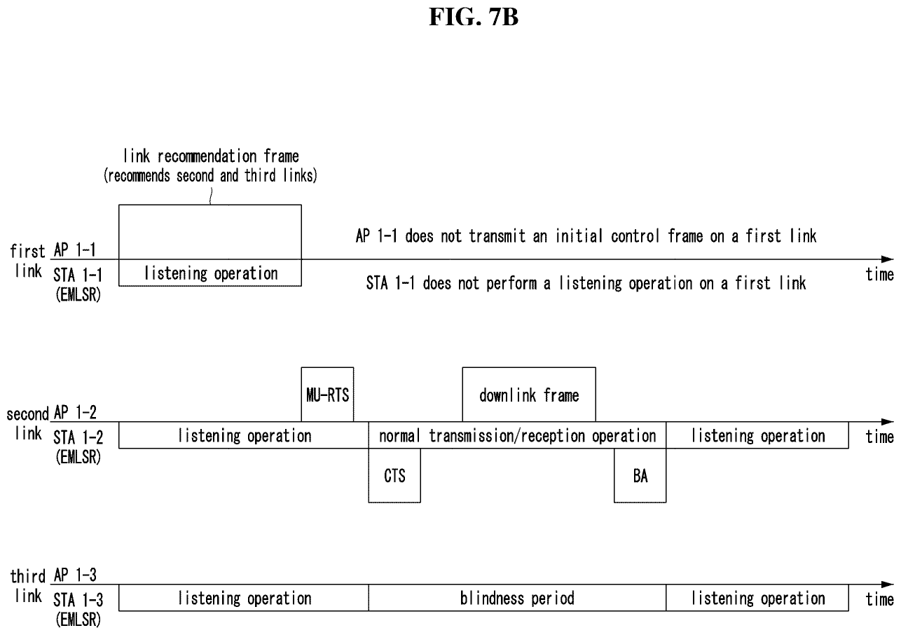

FIG. 7A is a timing diagram illustrating a first exemplary embodiment of a link change method for an EMLSR device in a wireless LAN supporting multiple links.

Referring to FIG. 7A, a STA MLD 1 may include a STA 1-1 operating on a first link and a STA 1-2 operating on a second link. An operation of the STA MLD 1 on the first link may be interpreted as an operation of the STA 1-1, and an operation of the STA MLD 1 on the second link may be interpreted as an operation of the STA 1-2. The STA MLD 1 may perform an EMLSR operation on the first link and the second link. In other words, the STA MLD 1 may be an EMLSR device (e.g., EMLSR STA MLD or EMLSR non-AP MLD). An AP MLD 1 may include an AP 1-1 operating on the first link and an AP 1-2 operating on the second link. An operation of the AP MLD 1 on the first link may be interpreted as an operation of the AP 1-1, and an operation of the AP MLD 1 on the second link may be interpreted as an operation of the AP 1-2.

The AP MLD (e.g., AP 1-1) may transmit a frame including link recommendation information to the STA MLD (e.g., STA 1-1). The frame including link recommendation information may be a link recommendation EHT action frame or a beacon frame. The frame including link recommendation information (e.g., link recommendation EHT action frame or beacon frame) may be referred to as ‘link recommendation frame’. The link recommendation information may indicate link(s) to be used. The AP MLD may transmit the link recommendation frame using a unicast or broadcast scheme. The link recommendation frame may include at least one of a link bitmap, a partial association identifier (AID) bitmap, or an AID bitmap. The link bitmap may be associated with bit positions of a partial AID bitmap or an AID bitmap. An association between the link bitmap and the partial AID bitmap (e.g., bit positions in the partial AID bitmap) may indicate link(s). Alternatively, an association between the link bitmap and the AID bitmap (e.g., bit positions in the AID bitmap) may indicate link(s). The link bitmap may be a per-link traffic indication list field included in a multi-link traffic indication element. The link recommendation frame may include information indicating link(s) to be used for uplink and/or link(s) to be used for downlink.

For example, the AP MLD 1 may transmit the link recommendation frame to the STA MLD 1. The STA MLD 1 may receive the link recommendation frame from the AP MLD 1. The link recommendation frame of the AP MLD 1 may recommend use of the second link. In this case, the STA MLD 1 may perform communication using the second link indicated by the link recommendation frame. In other words, when the link recommendation frame of the AP MLD 1 indicates the second link, the STA 1-2 may perform communication on the second link, and the STA 1-1 may not perform communication on the first link.

The STA MLD 1 (e.g., EMLSR STA MLD) may interpret the link recommendation frame of the AP MLD 1 as indicating stop of the EMLSR operation or reconfiguration of the EMLSR operation. The STA MLD 1 may not operate in (e.g., transition to) a listening operation state on the first link, and may perform a normal transmission and reception operation on the second link. In other words, the STA MLD 1 may stop the EMLSR operation. The link recommendation frame transmitted from the AP MLD 1 to the STA MLD 1 may be a frame that explicitly or implicitly indicates stop of the EMLSR operation. In a downlink communication procedure between the AP MLD 1 and the STA MLD 1, the AP MLD 1 may transmit a downlink frame (e.g., data frame, physical layer protocol data unit (PPDU), medium access control (MAC) layer protocol data unit (MPDU), aggregated MPDU (A-MPDU), or the like) to the STA MLD1 on the second link without transmitting an initial control frame (e.g., MU-RTS trigger frame or BSRP trigger frame). In other words, when it is confirmed that the STA MLD 1 does not perform the EMLSR operation, the AP MLD 1 may transmit a downlink frame to the STA MLD 1 on the second link without transmitting an initial control frame. The STA MLD 1 may receive the downlink frame of the AP MLD 1 without performing the EMLSR operation.

Before the AP MLD 1 transmits the link recommendation frame to the STA MLD 1, a preliminary operation to change the EMLSR operation may be performed. Alternatively, after the AP MLD 1 transmits the link recommendation frame to the STA MLD 1, a post-operation to change the EMLSR operation may be performed. For example, the AP MLD 1 and the STA MLD 1 may change the EMLSR operation before or after transmission of the link recommendation frame by exchanging EHT action frames (e.g., enhanced multi-link (EML) operating mode notification (OMN) frames). The change in the EMLSR operation may refer to a transition from a state in which the EMLSR operation is performed to a state in which the EMLSR operation is stopped. Alternatively, the change in the EMLSR operation may refer to a change (e.g., reconfiguration) of EMLSR link(s).

For example, the AP MLD 1 may indicate use of one link (e.g., the second link) among EMLSR links (e.g., the first and second links) of the STA MLD 1. The use of one link may be indicated by the link recommendation frame of the AP MLD 1. Before transmitting the link recommendation frame, the AP MLD 1 may indicate stop of the EMLSR operation by transmitting an EML OMN frame to the STA MLD 1. Alternatively, after receiving the link recommendation frame, the STA MLD 1 may indicate stop of the EMLSR operation by transmitting an EML OMN frame to the AP MLD 1. Alternatively, after transmitting the link recommendation frame, the AP MLD 1 may indicate stop of the EMLSR operation by transmitting an EML OMN frame to the STA MLD 1. The EML OMN frame of the AP MLD 1 and/or STA MLD 1 may request stop of the EMLSR operation.

Alternatively, after receiving the link recommendation frame of the AP MLD1, the STA MLD 1 may not stop the EMLSR operation on the second link. The AP MLD 1 may transmit an initial control frame to the STA MLD 1 in order to transmit a downlink frame. Since use of one link among the EMLSR links of the STA MLD1 is indicated, the AP MLD 1 may transmit the initial control frame to the STA MLD 1 without considering an EMLSR padding delay and/or EMLSR transition delay. In other words, the EMLSR padding delay and/or EMLSR transition delay may be considered or set to 0. The EMLSR padding delay or/and EMLSR transition delay of the STA MLD 1 may be considered or set to 0, and the STA MLD 1 may perform, without a delay, an operation of transitioning from a listening operation to a normal transmission/reception operation or an operation of transitioning from a normal transmission/reception operation to a listening operation.

In the above-described exemplary embodiment, the EMLSR operation may be interpreted as an enhanced multi-link multi radio (EMLMR) operation. For example, the EMLSR link may be an EMLMR link, and the STA MLD 1 may perform an EMLMR operation. In other words, the STA MLD 1 may be an EMLMR STA MLD. The EMLSR padding delay and the EMLSR transition delay may be interpreted as an EMLMR padding delay and an EMLMR transition delay, respectively.

FIG. 7B is a timing diagram illustrating a second exemplary embodiment of a link change method for an EMLSR device in a wireless LAN supporting multiple links.

Referring to FIG. 7B, a STA MLD 1 may include a STA 1-1 operating on a first link, a STA 1-2 operating on a second link, and a STA 1-3 operating on a third link. An operation of the STA MLD 1 on the first link may be interpreted as an operation of the STA 1-1, an operation of the STA MLD 1 on the second link may be interpreted as an operation of the STA 1-2, and an operation of the STA MLD on the third link may be interpreted as an operation of the STA 1-3. The STA MLD 1 may perform an EMLSR operation on the first link, second link, and third link. In other words, the STA MLD 1 may be an EMLSR device (e.g., EMLSR STA MLD or EMLSR non-AP MLD). An AP MLD 1 may include an AP 1-1 operating on the first link, an AP 1-2 operating on the second link, and an AP 1-3 operating on the third link. An operation of the AP MLD 1 on the first link may be interpreted as an operation of the AP 1-1, an operation of AP MLD 1 on the second link may be interpreted as an operation of the AP 1-2, and an operation of the AP MLD 1 on the third link may be interpreted as an operation of the AP 1-3.

The AP MLD (e.g., AP 1-1) may transmit a link recommendation frame to the STA MLD (e.g., STA 1-1). Link recommendation information may indicate link(s) to be used. The AP MLD may transmit the link recommendation frame using a unicast or broadcast scheme. The link recommendation frame may include at least one of a link bitmap, a partial AID bitmap, or an AID bitmap. The link bitmap may be associated with bit positions in a partial AID bitmap or an AID bitmap. An association between the link bitmap and the partial AID bitmap (e.g., bit positions in the partial AID bitmap) may indicate link(s). Alternatively, an association between the link bitmap and the AID bitmap (e.g., bit positions in the AID bitmap) may indicate link(s). The link bitmap may be a per-link traffic indication list field included in a multi-link traffic indication element. The link recommendation frame may include information indicating link(s) to be used for uplink and/or link(s) to be used for downlink.

For example, the AP MLD 1 may transmit the link recommendation frame to the STA MLD 1. The STA MLD 1 may receive the link recommendation frame from the AP MLD 1. The link recommendation frame of the AP MLD 1 may recommend use of the second link and the third link. In this case, the STA MLD 1 may perform communication using the second link and third link indicated by the link recommendation frame. In other words, when the link recommendation frame of the AP MLD 1 indicates the second link and the third link, the STA 1-2 may perform communication on the second link, the STA 1-3 may perform communication on the third link, and the STA 1-1 may not perform communication on the first link.

The STA MLD 1 (e.g., EMLSR STA MLD) may interpret the link recommendation frame of the AP MLD 1 as indicating stop of the EMLSR operation or reconfiguration of the EMLSR operation. The STA MLD 1 may perform the EMLSR operation on the second link and the third link without performing a listening operation on the first link. The STA MLD 1 may not use the first link. In other words, the STA MLD 1 may perform a listening operation on the second link and the third link to receive a downlink frame of the AP MLD 1. The link recommendation frame transmitted from the AP MLD 1 to the STA MLD 1 may be a frame that explicitly or implicitly indicates reconfiguration of the EMLSR operation. When the link recommendation frame (e.g., link recommendation frame indicating reconfiguration of the EMLSR operation) is received, and the link recommendation frame indicates the second link and the third link, the STA MLD 1 may reconfigure EMLSR links. For example, the STA MLD 1 may change the EMLSR links from the first, second, and third links to the second and third links.

In a downlink communication procedure between the AP MLD 1 and the STA MLD 1, the AP MLD 1 may transmit a downlink frame (e.g., data frame, PPDU, MPDU, A-MPDU, or the link) on the second and third links after transmitting an initial control frame (e.g., MU-RTS trigger frame or BSRP trigger frame). When it is confirmed that the STA MLD 1 performs the EMLSR operation, the AP MLD 1 may transmit a downlink frame after transmitting an initial control frame on the second link or the third link. The STA MLD 1 may perform the EMLSR operation on the second link and/or third link, and may receive the downlink frame according to the EMLSR operation.

Before the AP MLD 1 transmits the link recommendation frame to the STA MLD 1, a preliminary operation to change the EMLSR operation may be performed. Alternatively, after the AP MLD 1 transmits the link recommendation frame to the STA MLD 1, a post-operation to change the EMLSR operation may be performed. For example, the AP MLD 1 and the STA MLD 1 may change the EMLSR operation before or after transmission of the link recommendation frame by exchanging EHT action frames (e.g., EML OMN frames).

For example, the AP MLD 1 may indicate use of two links (e.g., the second and third links) among the EMLSR links (e.g., the first, second, and third links) of the STA MLD 1. The use of the two links may be indicated by the link recommendation frame of the AP MLD 1. Before transmitting the link recommendation frame, the AP MLD 1 may indicate change of the link(s) on which the EMLSR operation is performed by transmitting an EML OMN frame to the STA MLD 1. Alternatively, after receiving the link recommendation frame, the STA MLD 1 may indicate change of the link(s) on which the EMLSR operation is performed by transmitting an EML OMN frame to the AP MLD 1. Alternatively, after transmitting the link recommendation frame, the AP MLD 1 may indicate change of the link(s) on which the EMLSR operation is performed by transmitting an EML OMN frame to the STA MLD 1. The EML OMN frame of the AP MLD 1 and/or STA MLD 1 may indicate change of the link(s) on which the EMLSR operation is performed. The change of the link(s) may mean reconfiguration of the link(s).

When the links recommended by the AP MLD 1 includes one link on which the EMLSR operation of the STA MLD 1 is performed, the EMLSR operation may be stopped implicitly. Alternatively, the EMLSR operation may be stopped by the above-described procedure of exchanging EML OMN frames. When the links recommended by the AP MLD 1 includes two or more links on which the EMLSR operation of the STA MLD 1 is performed, the EMLSR operation may not be stopped. In other words, the EMLSR operation may be performed on two or more links recommended by the AP MLD 1.

In the above-described exemplary embodiment, the EMLSR operation may be interpreted as an EMLMR operation. For example, the EMLSR link may be an EMLMR link, and the STA MLD 1 may perform an EMLMR operation. In other words, the STA MLD 1 may be an EMLMR STA MLD. An EMLSR padding delay and EMLSR transition delay may be interpreted as an EMLMR padding delay and an EMLMR transition delay, respectively.

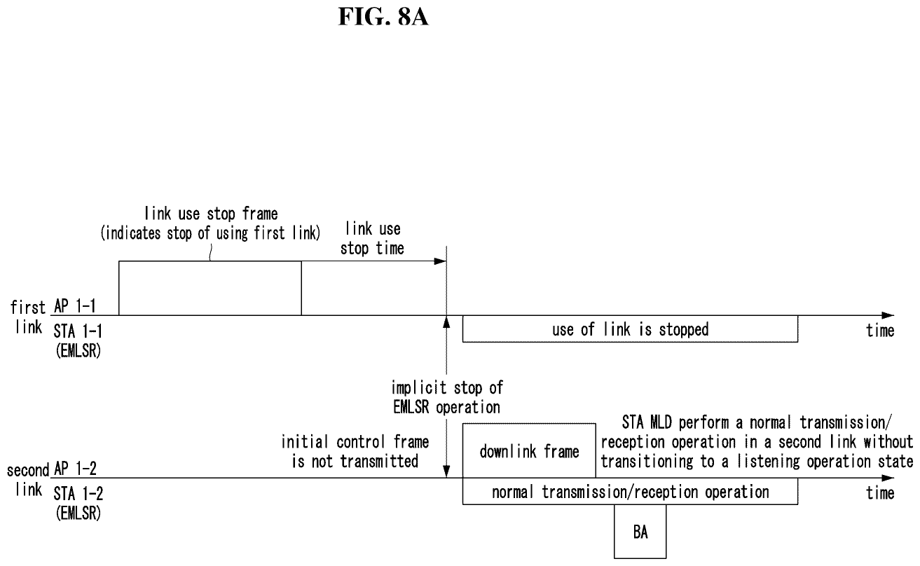

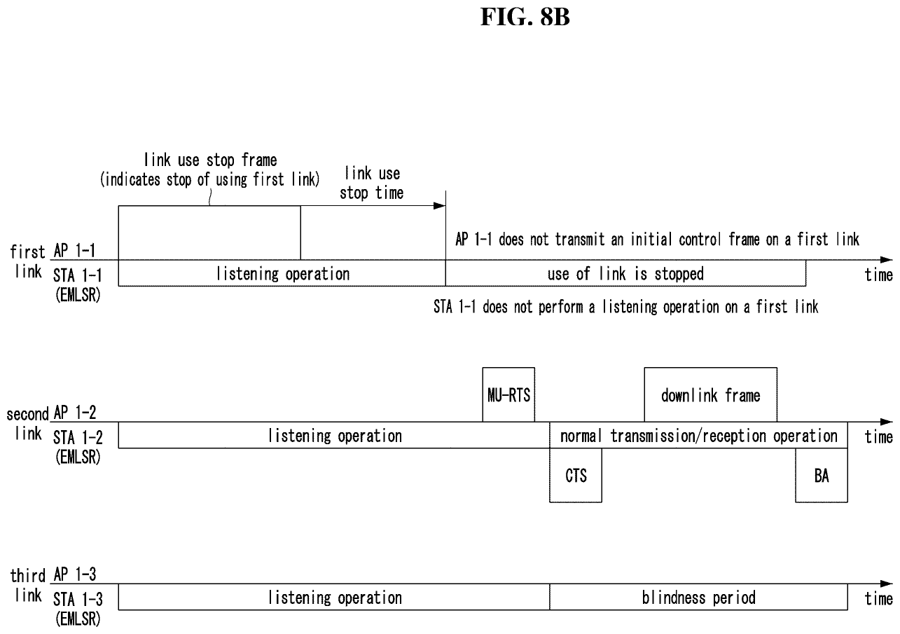

FIG. 8A is a timing diagram illustrating a third exemplary embodiment of a link change method for an EMLSR device in a wireless LAN supporting multiple links.

Referring to FIG. 8A, a STA MLD 1 may include a STA 1-1 operating on a first link and a STA 1-2 operating on a second link. An operation of the STA MLD 1 on the first link may be interpreted as an operation of the STA 1-1, and an operation of the STA MLD 1 on the second link may be interpreted as an operation of the STA 1-2. The STA MLD 1 may perform an EMLSR operation on the first link and the second link. In other words, the STA MLD 1 may be an EMLSR device (e.g., EMLSR STA MLD or EMLSR non-AP MLD). An AP MLD 1 may include an AP 1-1 operating on the first link and an AP 1-2 operating on the second link. An operation of the AP MLD 1 on the first link may be interpreted as an operation of the AP 1-1, and an operation of the AP MLD 1 on the second link may be interpreted as an operation of the AP 1-2.

The AP MLD 1 (e.g., AP 1-1) may transmit a frame (e.g., beacon frame or action frame (e.g., EHT action frame)) including traffic identifier (TID)-to-link mapping information to the STA MLD 1 (e.g., STA 1-1). The beacon frame may be transmitted in a broadcast scheme, and the EHT action frame may be transmitted in a unicast scheme. The TID-to-link mapping information transmitted from the AP MLD 1 to the STA MLD 1 may indicate stop of using link(s). For example, when a specific link is not mapped to any TID in the TID-to-link mapping information, the TID-to-link mapping information may indicate stop of using the specific link. The ‘stop of using’ may mean ‘suspension of using’.

That a specific link is not mapped to any TID in the TID-to-link mapping information may means that there is no TID mapped to the specific link in the TID-to-link mapping information or that the TID-to-link mapping information does not include mapping information between the specific link and a TID. When use of a specific link is stopped, all transmission and reception operations may not be performed on the specific link. Conversely, when a specific link is mapped to at least one TID in the TID-to-link mapping information, the TID-to-link mapping information may indicate that the specific link can be used.

For example, the AP MLD 1 may transmit a beacon frame including the TID-to-link mapping information to the STA MLD 1. The beacon frame (e.g., TID-to-link mapping information) transmitted by the AP MLD 1 may indicate stop of using the first link. The beacon frame of the AP MLD 1 may include information on a time (i.e., link use stop time) at which the use of the first link is stopped. The beacon frame indicating stop of using the first link may be referred to as ‘link use stop information (e.g., link use stop frame)’. The link use stop time may be indicated by an offset from a time of receiving the link use stop frame to a time at which use of the link is stopped.

The STA MLD 1 may receive the beacon frame (e.g., link use stop frame) from the AP MLD 1, and identify information elements (e.g., TID-to-link mapping information and/or information on the link use stop time) included in the beacon frame. The STA MLD 1 may confirm that use of the first link is stopped. In addition, the STA MLD 1 may confirm the time at which use of the first link is stopped. The STA MLD 1 may perform communication using the second link after the link use stop time of the first link. In other words, after the link use stop time of the first link, the STA 1-2 may perform communication on the second link, and the STA 1-1 may not perform communication on the first link.

The STA MLD 1 (e.g., EMLSR STA MLD) may interpret the link use stop indication of the AP MLD1 as indicating stop of the EMLSR operation or reconfiguration of the EMLSR operation. After the link use stop time of the first link, the STA MLD 1 may not operate in (e.g., transition to) a listening operation state on the first link and may perform a normal transmission and reception operation on the second link. In other words, the STA MLD 1 may stop the EMLSR operation after the link use stop time of the first link. When only one link among the EMLSR links can be used due to the link use stop indication from the AP MLD 1, the STA MLD 1 may stop the EMLSR operation. The link use stop indication of the AP MLD 1 may implicitly indicate stop of the EMLSR operation. In a downlink communication procedure between the AP MLD 1 and the STA MLD 1, the AP MLD 1 may transmit a downlink frame (e.g., data frame, PPDU, MPDU, A-MPDU, etc.) to the STA MLD 1 on the second link without transmitting an initial control frame (e.g., MU-RTS trigger frame or BSRP trigger frame). When it is confirmed that the EMLSR operation of the STA MLD 1 is stopped, the AP MLD 1 may transmit a downlink frame to the STA MLD 1 on the second link without transmitting an initial control frame. The STA MLD 1 may receive the downlink frame of the AP MLD 1 without performing the EMLSR operation.

Before the AP MLD 1 transmits the link use stop information to the STA MLD 1, a preliminary operation to change the EMLSR operation may be performed. Alternatively, after the AP MLD 1 transmits the link use stop information to the STA MLD 1, a post-operation to change the EMLSR operation may be performed. For example, the AP MLD 1 and the STA MLD 1 may change the EMLSR operation before or after transmission of the link use stop information by exchanging EHT action frames (e.g., EML OMN frames).

For example, the AP MLD 1 may indicate stop of using one link (e.g., the first link) among the EMLSR links (e.g., the first and second links) of the STA MLD 1. The stop of using one link may be indicated by the link use stop information of the AP MLD 1. Before transmitting the link use stop information, the AP MLD 1 may indicate stop of the EMLSR operation by transmitting an EML OMN frame to the STA MLD 1. Alternatively, after receiving the link use stop information, the STA MLD 1 may indicate stop of the EMLSR operation by transmitting an EML OMN frame to the AP MLD 1. Alternatively, after transmitting the link use stop information, the AP MLD 1 may indicate stop of the EMLSR operation by transmitting an EML OMN frame to the STA MLD 1. The EML OMN frame of the AP MLD 1 and/or STA MLD 1 may request stop of the EMLSR operation.

Alternatively, after receiving the link use stop frame of the AP MLD1, the STA MLD 1 may not stop the EMLSR operation on the second link. The AP MLD 1 may transmit an initial control frame to the STA MLD 1 in order to transmit a downlink frame. Since only one link among the EMLSR links of the STA MLD1 can be used, the AP MLD 1 may transmit an initial control frame to the STA MLD 1 without considering an EMLSR padding delay and/or EMLSR transition delay. In other words, the EMLSR padding delay and/or EMLSR transition delay may be considered or set to 0. The EMLSR padding delay or/and EMLSR transition delay of the STA MLD 1 may be considered or set to 0, and the STA MLD 1 may perform, without a delay, an operation of transitioning from a listening operation to a normal transmission/reception operation or an operation of transitioning from a normal transmission/reception operation to a listening operation.

In the above-described exemplary embodiment, the EMLSR operation may be interpreted as an EMLMR operation. For example, the EMLSR link may be an EMLMR link, and the STA MLD 1 may perform an EMLMR operation. In other words, the STA MLD 1 may be an EMLMR STA MLD. The EMLSR padding delay and the EMLSR transition delay may be interpreted as an EMLMR padding delay and an EMLMR transition delay, respectively.

FIG. 8B is a timing diagram illustrating a fourth exemplary embodiment of a link change method for an EMLSR device in a wireless LAN supporting multiple links.

Referring to FIG. 8B, a STA MLD 1 may include a STA 1-1 operating on a first link, a STA 1-2 operating on a second link, and a STA 1-3 operating on a third link. An operation of the STA MLD 1 on the first link may be interpreted as an operation of the STA 1-1, an operation of the STA MLD 1 on the second link may be interpreted as an operation of the STA 1-2, and an operation of the STA MLD on the third link may be interpreted as an operation of the STA 1-3. The STA MLD 1 may perform an EMLSR operation on the first link, second link, and third link. In other words, the STA MLD 1 may be an EMLSR device (e.g., EMLSR STA MLD or EMLSR non-AP MLD). An AP MLD 1 may include an AP 1-1 operating on the first link, an AP 1-2 operating on the second link, and an AP 1-3 operating on the third link. An operation of the AP MLD 1 on the first link may be interpreted as an operation of the AP 1-1, an operation of the AP MLD 1 on the second link may be interpreted as an operation of the AP 1-2, and an operation of the AP MLD 1 on the third link may be interpreted as an operation of the AP 1-3.

The AP MLD 1 (e.g., AP 1-1) may transmit a frame (e.g., beacon frame or EHT action frame) including TID-to-link mapping information to the STA MLD 1 (e.g., STA 1-1). The beacon frame may be transmitted in a broadcast scheme, and the EHT action frame may be transmitted in a unicast scheme. The TID-to-link mapping information transmitted from the AP MLD to the STA MLD may indicate stop of using link(s). For example, when a specific link is not mapped to any TID in the TID-to-link mapping information, the TID-to-link mapping information may indicate stop of using the specific link. When the use of the specific link is stopped, all transmission/reception operations on the specific link may not be performed.

For example, the AP MLD 1 may transmit a beacon frame including the TID-to-link mapping information to the STA MLD 1. The beacon frame (e.g., TID-to-link mapping information) transmitted by the AP MLD 1 may indicate stop of using the first link. The beacon frame of the AP MLD 1 may include information on a time (i.e., link use stop time) at which the use of the first link is stopped. The beacon frame indicating stop of using the first link may be referred to as link use stop information (e.g., link use stop frame). The STA MLD 1 may receive the beacon frame (e.g., link use stop frame) from the AP MLD 1, and identify information elements (e.g., TID-to-link mapping information and/or information on the link use stop time) included in the beacon frame. The STA MLD 1 may confirm that use of the first link is stopped. In addition, the STA MLD 1 may confirm the link use stop time of the first link. The STA MLD 1 may perform communication using the second link and the third link after the link use stop time of the first link. In other words, after the link use stop time of the first link, the STA 1-2 may perform communication on the second link, the STA 1-3 may perform communication on the third link, and the STA 1-1 may not perform communication on the first link.

The STA MLD 1 (e.g., EMLSR STA MLD) may interpret the link use stop indication of the AP MLD1 as indicating stop of the EMLSR operation or reconfiguration of the EMLSR operation. After the link use stop time of the first link, the STA MLD 1 may not perform a listening operation on the first link and may perform an EMLSR operation on the second link and the third link. Before the link use stop time of the first link, the EMLSR links may include the first link, the second link, and the third link, and after the link use stop time of the first link, the EMLSR links may include the second link and the third link. The STA MLD 1 may reconfigure the EMLSR links based on the link use stop indication of the AP MLD 1. The STA MLD 1 may perform the EMLSR operation (e.g., listening operation) on the first link, the second link, and the third link before the link use stop time of the first link, and may perform the EMLSR operation (e.g., listening operation) on the second link and the third link after the link use stop time of the first link.

The STA MLD 1 may not use the first link after the link use stop time of the first link. In other words, the STA MLD 1 may perform a listening operation on the second link and the third link to receive a downlink frame after the link use stop time of the first link. In a downlink communication procedure between the AP MLD 1 and the STA MLD 1 after the link use stop time of the first link, the AP MLD 1 may transmit an initial control frame (e.g., MU-RTS trigger frame or BSRP trigger frame) on the second or third link, and then transmit a downlink frame (e.g., data frame, PPDU, MPDU, A-MPDU, etc.) to the STA MLD 1. In other words, when it is confirmed that the STA MLD 1 performs the EMLSR operation, the AP MLD 1 may transmit a downlink frame to the STA MLD 1 after transmitting the initial control frame on the second link or the third link. The STA MLD 1 may receive the downlink frame of the AP MLD 1 based on the EMLSR operation. The STA MLD 1 may perform the EMLSR operation on the second link and/or third link, and may receive the downlink frame according to the EMLSR operation.

A preliminary operation to change the EMLSR operation may be performed before the AP MLD 1 transmits the link use stop information to the STA MLD 1. Alternatively, after the AP MLD 1 transmits the link use stop information to the STA MLD 1, a post-operation to change the EMLSR operation may be performed. For example, the AP MLD 1 and the STA MLD 1 may change the EMLSR operation before or after transmission of the link use stop information by exchanging EHT action frames (e.g., EML OMN frames).

For example, the AP MLD 1 may indicate stop of using one link (e.g., the first link) among the EMLSR links (e.g., the first link, the second link, and the third link) of the STA MLD1. The stop of using one link may be indicated by link use stop information of the AP MLD 1. Before transmitting the link use stop information, the AP MLD 1 may indicate change of the link(s) on which the EMLSR operation is performed by transmitting an EML OMN frame to the STA MLD 1. Alternatively, after receiving the link use stop information, the STA MLD 1 may indicate change of the link(s) on which the EMLSR operation is performed by transmitting an EML OMN frame to the AP MLD 1. Alternatively, after transmitting the link use stop information, the AP MLD 1 may indicate change of the link(s) on which the EMLSR operation is performed by transmitting an EML OMN frame to the STA MLD 1. The EML OMN frame of AP MLD 1 and/or STA MLD 1 may request stop of the EMLSR operation. The EML OMN frame of the AP MLD 1 and/or STA MLD 1 may indicate change of the link(s) on which the EMLSR operation is performed. The change of the link(s) may mean reconfiguration of the link(s).

In the above-described exemplary embodiment, the EMLSR operation may be interpreted as an EMLMR operation. For example, the EMLSR link may be an EMLMR link, and the STA MLD 1 may perform an EMLMR operation. In other words, the STA MLD 1 may be an EMLMR STA MLD. The EMLSR padding delay and the EMLSR transition delay may be interpreted as an EMLMR padding delay and an EMLMR transition delay, respectively.

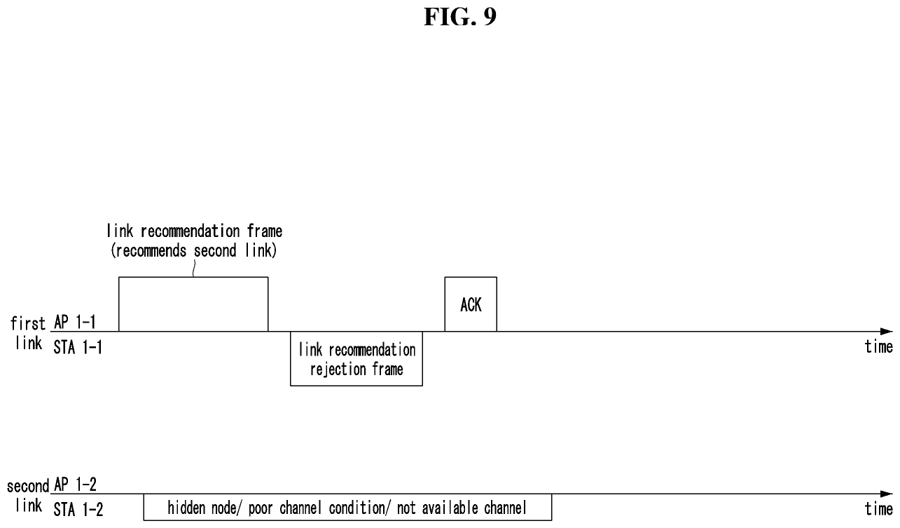

FIG. 9 is a timing diagram illustrating a first exemplary embodiment of a link change method in a wireless LAN supporting multiple links.

Referring to FIG. 9, a STA MLD 1 may include a STA 1-1 operating on a first link and a STA 1-2 operating on a second link. An operation of the STA MLD 1 on the first link may be interpreted as an operation of the STA 1-1, and an operation of the STA MLD 1 on the second link may be interpreted as an operation of the STA 1-2. The STA MLD 1 may perform an EMLSR operation on the first link and the second link. In other words, the STA MLD 1 may be an EMLSR device (e.g., EMLSR STA MLD or EMLSR non-AP MLD). An AP MLD 1 may include an AP 1-1 operating on the first link and an AP 1-2 operating on the second link. An operation of the AP MLD 1 on the first link may be interpreted as an operation of the AP 1-1, and an operation of AP MLD 1 on the second link may be interpreted as an operation of the AP 1-2.

The AP MLD 1 may transmit a link recommendation frame (e.g., EHT action frame) to the STA MLD 1. The EHT action frame may be used to recommend link(s). The AP MLD may transmit the link recommendation frame using a unicast or broadcast scheme. The link recommendation frame may include at least one of a link bitmap, a partial AID bitmap, or an AID bitmap. The link recommendation frame may include information indicating link(s) to be used for uplink and/or link(s) to be used for downlink.

For example, the AP MLD 1 may transmit the link recommendation frame to the STA MLD 1. The STA MLD 1 may receive the link recommendation frame from the AP MLD 1. The link recommendation frame of the AP MLD 1 may recommend use of the second link. Interference due to a hidden node may occur on the second link, and in this case, use of the second link may be impossible. A channel condition may be poor on the second link, in which case use of the second link may be impossible. Use of the second link may be impossible for other reasons.

When use of the second link is impossible, the STA MLD 1 may transmit a link recommendation rejection frame (e.g., link recommendation response frame) to the AP MLD 1. The link recommendation rejection frame may be a separate EHT action frame or an arbitrary frame. The type (e.g., format) of the link recommendation rejection frame may be identical or similar to the type (e.g., format) of the link recommendation frame. The AP MLD 1 may receive the link recommendation rejection frame from the STA MLD 1. When the link recommendation rejection frame is received, the AP MLD 1 may determine that the second link recommended by the link recommendation frame cannot be used.

The AP MLD 1 may transmit a response frame (e.g., acknowledgment (ACK) frame or block ACK (BA) frame) for the link recommendation rejection frame to the STA MLD 1. Alternatively, transmission of the response frame to the link recommendation rejection frame may be omitted. According to the link recommendation rejection frame of the STA MLD 1, communication operations and configurations (e.g., EMLSR operations/configurations, uplink operations/configurations, downlink operations/configurations) between the AP MLD 1 and the STA MLD 1 may not be changed.

The link recommendation rejection frame transmitted from the STA MLD 1 to the AP MLD 1 may include a list (e.g., information) of link(s) preferred by the STA MLD 1. The link(s) preferred by the STA MLD 1 may be link(s) that the STA MLD 1 wishes to use. The AP MLD 1 may confirm the link(s) preferred by the STA MLD 1 based on the information included in the link recommendation rejection frame, and may transmit a link recommendation frame considering the link(s) preferred by the STA MLD 1. The procedure of stopping and/or reconfiguring the EMLSR operation according to the exemplary embodiment of FIG. 7A and/or the exemplary embodiment of FIG. 7B described above may be performed. The operations according to the link recommendation rejection frame of FIG. 9 may be applied to the exemplary embodiment(s) of FIGS. 7A, 7B, 8A, and/or 8B.

In the above-described exemplary embodiment, the EMLSR operation may be interpreted as an EMLMR operation. For example, the EMLSR link may be an EMLMR link, and the STA MLD 1 may perform an EMLMR operation. In other words, the STA MLD 1 may be an EMLMR STA MLD. The EMLSR padding delay and the EMLSR transition delay may be interpreted as an EMLMR padding delay and an EMLMR transition delay, respectively.

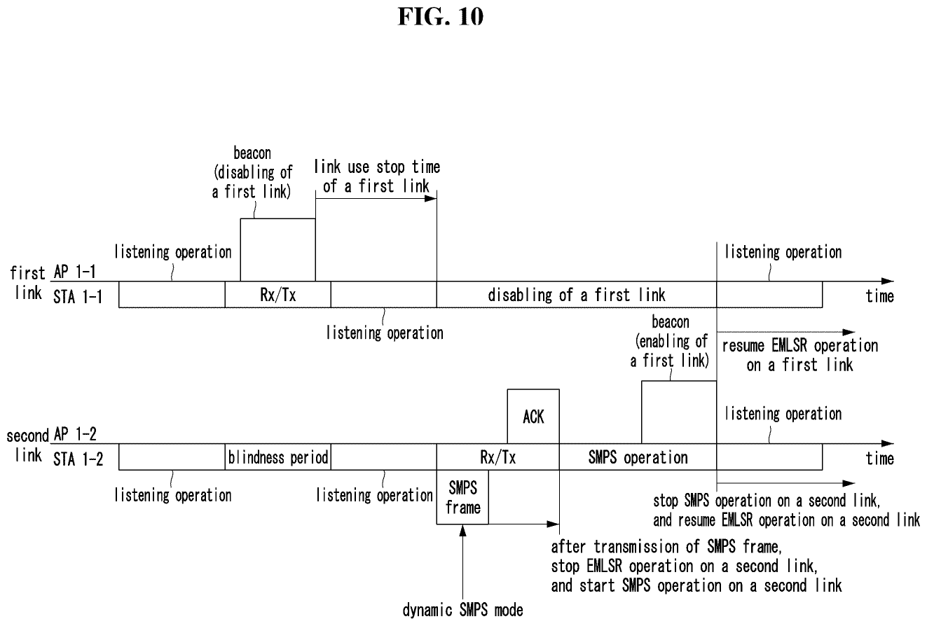

FIG. 10 is a timing diagram illustrating a fifth exemplary embodiment of a link change method in a wireless LAN supporting multiple links.

Referring to FIG. 10, a STA MLD 1 may include a STA 1-1 operating on a first link and a STA 1-2 operating on a second link. An operation of the STA MLD 1 on the first link may be interpreted as an operation of the STA 1-1, and an operation of the STA MLD 1 on the second link may be interpreted as an operation of the STA 1-2. The STA MLD 1 may perform an EMLSR operation on the first link and the second link. In other words, the STA MLD 1 may be an EMLSR device (e.g., EMLSR STA MLD or EMLSR non-AP MLD). The first link and the second link may be EMLSR links. The AP MLD 1 may include an AP 1-1 operating on the first link and an AP 1-2 operating on the second link. An operation of the AP MLD 1 on the first link may be interpreted as an operation of the AP 1-1, and an operation of the AP MLD 1 on the second link may be interpreted as an operation of the AP 1-2.

The AP MLD 1 (e.g., AP 1-1) may transmit a frame (e.g., beacon frame or EHT action frame) including TID-to-link mapping information to the STA MLD 1 (e.g., STA 1-1). The beacon frame may be transmitted in a broadcast scheme, and the EHT action frame may be transmitted in a unicast scheme. The TID-to-link mapping information transmitted from the AP MLD 1 to the STA MLD 1 may indicate stop of using link(s). For example, when a specific link is not mapped to any TID in the TID-to-link mapping information, the TID-to-link mapping information may indicate stop of using the specific link. When the use of the specific link is stopped, all transmission/reception operations on the specific link may not be performed.

For example, the AP MLD 1 may transmit a beacon frame including the TID-to-link mapping information to the STA MLD 1. The beacon frame (e.g., TID-to-link mapping information) transmitted by the AP MLD 1 may indicate stop of using the first link. The stop of using the first link may mean disabling of the first link. The beacon frame of the AP MLD 1 may include information on a time (i.e., link use stop time) at which the use of the first link is stopped. The beacon frame or EHT action frame indicating stop of using the first link may be referred to as link use stop information (e.g., link use stop frame). The link use stop information may be transmitted also on the second link. In other words, the link use stop information may be transmitted on the first link and the second link. The STA MLD 1 may receive the beacon frame (e.g., link use stop frame) from the AP MLD 1, and identify information elements included in the beacon frame (e.g., TID-to-link mapping information and/or information on the link use stop time). The STA MLD 1 may confirm that use of the first link is stopped. In addition, the STA MLD 1 may confirm the link use stop time of the first link.

After the link use stop time of the first link, use of the first link may be stopped. The STA 1-2 of the STA MLD 1 may transmit a spatial multiplexing power saving (SMPS) frame to the AP 1-2 on the second link. For example, the SMPS frame may be transmitted when at least one (e.g., available link) among the EMLSR links remains. The SMPS frame may indicate use of SMPS and/or an SMPS mode. The SMPS mode may be classified into a dynamic SMPS mode and a static SMPS mode. The SMPS frame may be a high throughput (HT) action frame. The STA 1-2 may transmit, to the AP 1-2, an SMPS frame including information indicating that the dynamic SMPS mode is used.

The AP 1-2 may receive the SMPS frame from the STA 1-2 and may transmit a response frame (e.g., ACK frame) for the SMPS frame to the STA 1-2. The AP 1-2 may identify information element(s) included in the SMPS frame. For example, the AP 1-2 may confirm that the STA 1-2 operates in the dynamic SMPS mode based on the information element(s) included in the SMPS frame. The STA 1-2 may perform an SMPS operation instead of a listening operation after transmitting the SMPS frame. In other words, the STA 1-2 may not perform the EMLSR operation after transmission of the SMPS frame. The EMLSR operation may be suspended.

The AP 1-2 may not transmit an initial control frame (e.g., EMLSR initial control frame) to transmit a data frame to the STA 1-2. When it is confirmed that the STA 1-2 does not perform the EMLSR operation, the AP 1-2 may not transmit an initial control frame to transmit a data frame to the STA 1-2. The STA 1-2 may not receive an initial control frame to receive a data frame from the AP 1-2. In other words, an initial control frame may not be needed in a data transmission procedure between the AP 1-2 and the STA 1-2. When the STA 1-2 operates in the dynamic SMPS mode, the AP 1-2 may transmit a first frame to the STA 1-2 using one spatial stream. The first frame may be an RTS frame or a data frame. The STA 1-2 may receive the first frame from the AP 1-2 and transmit a response for the first frame to the AP 1-2. When the response for the first frame is received, the AP 1-2 may transmit a frame (e.g., second frame) to the STA 1-2 using multiple spatial streams. Alternatively, the STA 1-2 may operate in the static SMPS mode. In this case, the AP 1-2 may transmit frame(s) to the STA 1-2 using one spatial stream.

The AP 1-2 may indicate start of using the first link. In other words, the AP 1-2 may transmit information indicating start of using the first link. The start of using the first link may mean enabling of the first link. For example, the AP MLD 1 may re-perform TID-to-link mapping for the first link. The AP MLD 1 may re-perform TID-to-link mapping so that at least one TID is mapped to the first link. The AP MLD 1 (e.g., AP 1-2) may transmit a frame (e.g., beacon frame or EHT action frame) including the TID-to-link mapping information to the STA MLD 1 (e.g., STA 1-2). The beacon frame may be transmitted in a broadcast scheme, and the EHT action frame may be transmitted in a unicast scheme. The STA MLD 1 may receive the TID-to-link mapping information from the AP MLD 1 and confirm that use of the first link is started based on the TID-to-link mapping information. In other words, the STA MLD 1 may confirm that the first link is enabled based on the TID-to-link mapping information.

The use of the first link may start from a time at which the AP 1-2 indicates the start of using the first link or from a separate time indicated by the AP 1-2. Alternatively, when a beacon frame (e.g., beacon frame indicating start of using the first link) is received on the first link, the use of the first link may be started. The beacon frame or action frame (e.g., EHT action frame) indicating the start of using the first link, which is transmitted by AP MLD 1, may be referred to as ‘link use start information’. The link use start information of the AP MLD 1 may be transmitted also on the second link. In other words, the link use start information of the AP MLD 1 may be transmitted on the first link and the second link.

When use of the first link is started or when the STA 1-1 receives the beacon frame from the AP 1-1 on the first link after use of the first link is started, the STA 1-1 of the STA MLD 1 may perform a listening operation. When use of the first link is started or when the STA 1-1 receives the beacon frame from the AP 1-1 on the first link after use of the first link is started, the STA 1-2 of the STA MLD 1 may stop the SMPS operation and perform a listening operation. The AP MLD 1 may transmit an initial control frame to the STA MLD 1 in order to transmit a frame to the STA MLD 1. Alternatively, the STA 1-2 may stop the SMPS operation by transmitting an SMPS frame to the AP 1-2. The SMPS frame of the STA 1-2 may indicate that the SMPS operation is stopped.

In the above-described exemplary embodiment, the start and/or stop of the SMPS operation may be indicated by a frame according to an (re) association procedure (e.g., (re) association request frame, (re) association response frame) instead of the SMPS frame. For example, the AP 1-2 and the STA 1-2 may perform a (re) association procedure, and the SMPS operation may be started or stopped in the (re) association procedure.

In the above-described exemplary embodiment, the EMLSR operation may be interpreted as an EMLMR operation. For example, the EMLSR link may be an EMLMR link, and the STA MLD 1 may perform an EMLMR operation. In other words, the STA MLD 1 may be an EMLMR STA MLD. The EMLSR padding delay and the EMLSR transition delay may be interpreted as an EMLMR padding delay and an EMLMR transition delay, respectively.

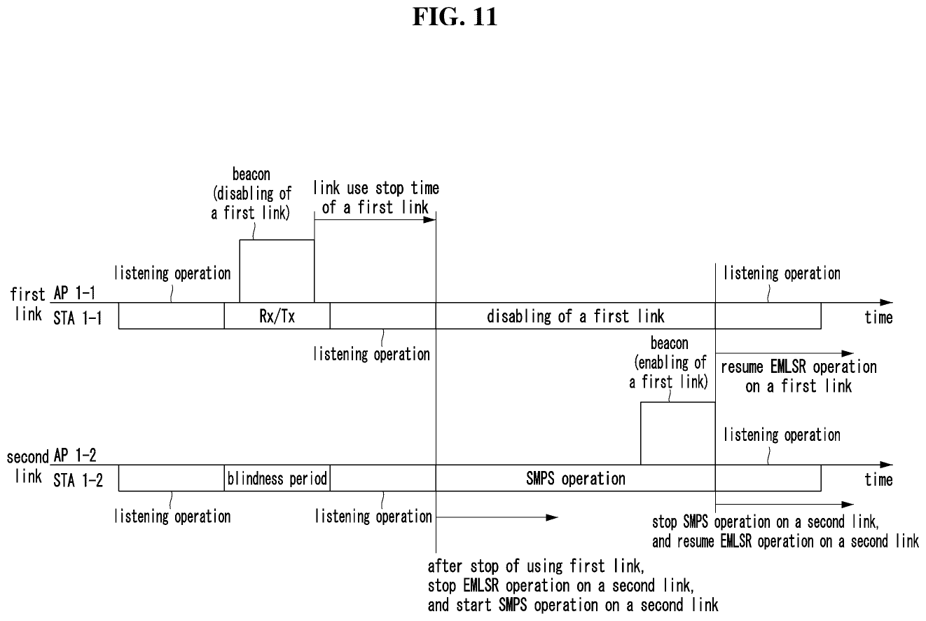

FIG. 11 is a timing diagram illustrating a sixth exemplary embodiment of a link change method in a wireless LAN supporting multiple links.

Referring to FIG. 11, a STA MLD 1 may include a STA 1-1 operating on a first link and a STA 1-2 operating on a second link. An operation of the STA MLD 1 on the first link may be interpreted as an operation of the STA 1-1, and an operation of the STA MLD 1 on the second link may be interpreted as an operation of the STA 1-2. The STA MLD 1 may perform an EMLSR operation on the first link and the second link. In other words, the STA MLD 1 may be an EMLSR device (e.g., EMLSR STA MLD or EMLSR non-AP MLD). The first link and the second link may be EMLSR links. The AP MLD 1 may include an AP 1-1 operating on the first link and an AP 1-2 operating on the second link. An operation of the AP MLD 1 on the first link may be interpreted as an operation of the AP 1-1, and an operation of the AP MLD 1 on the second link may be interpreted as an operation of the AP 1-2.

The AP MLD 1 (e.g., AP 1-1) may transmit a frame (e.g., beacon frame or EHT action frame) including TID-to-link mapping information to the STA MLD 1 (e.g., STA 1-1). The beacon frame may be transmitted in a broadcast scheme, and the EHT action frame may be transmitted in a unicast scheme. The TID-to-link mapping information transmitted from the AP MLD 1 to the STA MLD 1 may indicate stop of using link(s). For example, when a specific link is not mapped to any TID in the TID-to-link mapping information, the TID-to-link mapping information may indicate stop of using the specific link. When the use of the specific link is stopped, all transmission/reception operations on the specific link may not be performed.

For example, the AP MLD 1 may transmit a beacon frame including the TID-to-link mapping information to the STA MLD 1. The beacon frame (e.g., TID-to-link mapping information) transmitted by the AP MLD 1 may indicate stop of using the first link. The stop of using the first link may mean disabling of the first link. The beacon frame of the AP MLD 1 may include information on a time (i.e., link use stop time) at which the use of the first link is stopped. The beacon frame or EHT action frame indicating stop of using the first link may be referred to as link use stop information (e.g., link use stop frame). The link use stop information may be transmitted also on the second link. In other words, the link use stop information may be transmitted on the first link and the second link. The STA MLD 1 may receive the beacon frame (e.g., link use stop frame) from the AP MLD 1, and identify information elements included in the beacon frame (e.g., TID-to-link mapping information and/or information on the link use stop time). The STA MLD 1 may confirm that use of the first link is stopped. In addition, the STA MLD 1 may confirm the link use stop time of the first link.

After the link use stop time of the first link, use of the first link may be stopped. The STA 1-2 of the STA MLD 1 may not perform a listening operation, and may operate in the dynamic SMPS mode without transmitting a separate frame. In other words, the STA 1-2 may stop (e.g., temporarily suspend) the EMLSR operation. The AP 1-2 may not transmit an initial control frame (e.g., EMLSR initial control frame) to the STA 1-2. When the STA 1-2 operates in the dynamic SMPS mode, the AP 1-2 may transmit a first frame to the STA 1-2 using one spatial stream. The first frame may be an RTS frame or a data frame. The STA 1-2 may receive the first frame from the AP 1-2 and transmit a response for the first frame to the AP 1-2. When the response for the first frame is received, the AP 1-2 may transmit a frame (e.g., second frame) to the STA 1-2 using multiple spatial streams. Alternatively, the STA 1-2 may operate in the static SMPS mode. In this case, the AP 1-2 may transmit frame(s) to the STA 1-2 using one spatial stream.

The STA MLD 1 may not receive information indicating stop of using the first link from the AP MLD 1. In this case, the STA MLD 1 may perform the EMLSR operation on the first link and the second link. The AP 1-2 may transmit a frame other than an initial control frame to the STA 1-2. The STA 1-2 may not receive the frame transmitted by the AP 1-2. In this case, the STA 1-2 may not be able to transmit a response for the frame of the AP 1-2. When the response to the frame of the AP 1-2 is not received, the AP 1-2 may determine that the STA 1-2 does not perform the SMPS operation. In other words, the AP 1-2 may determine that the STA 1-2 performs the EMLSR operation instead of the SMPS operation. When it is determined that the STA 1-2 performs the EMLSR operation, the AP 1-2 may transmit an initial control frame (e.g., EMLSR initial control frame) to the STA 1-2.

The AP 1-2 may indicate start of using the first link. In other words, the AP 1-2 may transmit information indicating start of using the first link. The start of using the first link may mean enabling of the first link. For example, the AP MLD 1 may re-perform TID-to-link mapping for the first link. The AP MLD 1 may re-perform TID-to-link mapping so that at least one TID is mapped to the first link. The AP MLD 1 (e.g., AP 1-2) may transmit a frame (e.g., beacon frame or EHT action frame) including the TID-to-link mapping information to the STA MLD 1 (e.g., STA 1-2). The beacon frame may be transmitted in a broadcast scheme, and the EHT action frame may be transmitted in a unicast scheme. The STA MLD 1 may receive the TID-to-link mapping information from the AP MLD 1 and confirm that use of the first link is started based on the TID-to-link mapping information. In other words, the STA MLD 1 may confirm that the first link is enabled based on the TID-to-link mapping information.

The use of the first link may start from a time at which the AP 1-2 indicates the start of using the first link or from a separate time indicated by the AP 1-2. Alternatively, when the beacon frame (e.g., beacon frame indicating the start of using the first link) is received on the first link, the use of the first link may be started. The beacon frame or action frame (e.g., EHT action frame) indicating the start of using the first link, which is transmitted by the AP MLD 1, may be referred to as ‘link use start information’. The link use start information of the AP MLD 1 may be transmitted also on the second link. In other words, the link use start information of the AP MLD 1 may be transmitted on the first link and the second link.

When the use of the first link is started or when the STA 1-1 receives the beacon frame from the AP 1-1 on the first link after the use of the first link is started, the STA 1-1 of the STA MLD 1 may perform a listening operation. When the use of the first link is started or when the STA 1-1 receives the beacon frame from the AP 1-1 on the first link after the use of the first link is started, the STA 1-2 of the STA MLD 1 may stop the SMPS operation and perform a listening operation. The AP MLD 1 may transmit an initial control frame to the STA MLD 1 in order to transmit a frame to the STA MLD 1. Alternatively, the STA 1-2 may stop the SMPS operation by transmitting an SMPS frame to the AP 1-2. The SMPS frame of the STA 1-2 may indicate that the SMPS operation is stopped.

In the above-described exemplary embodiment, the start and/or stop of the SMPS operation may be indicated by a frame according to a (re) association procedure (e.g., (re) association request frame, (re) association response frame) instead of the SMPS frame. For example, the AP 1-2 and the STA 1-2 may perform a (re) association procedure, and the SMPS operation may be started or stopped in the (re) association procedure.

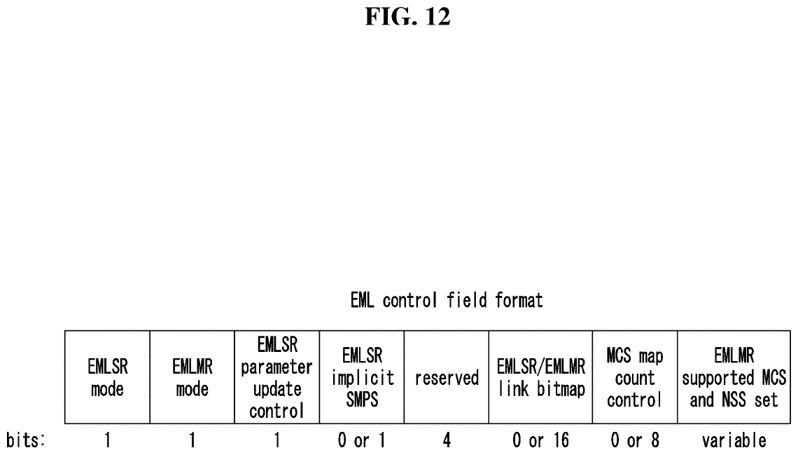

The above-described exemplary embodiment may be performed based on an EMLSR configuration procedure between the AP MLD 1 and the STA MLD 1. A control field shown in FIG. 12 may be used in the EMLSR configuration procedure.

In the above-described exemplary embodiment, the EMLSR operation may be interpreted as an EMLMR operation. For example, the EMLSR link may be an EMLMR link, and the STA MLD 1 may perform an EMLMR operation. In other words, the STA MLD 1 may be an EMLMR STA MLD. The EMLSR padding delay and the EMLSR transition delay may be interpreted as an EMLMR padding delay and an EMLMR transition delay, respectively.

FIG. 12 is a block diagram illustrating a first exemplary embodiment of a control field format for EMLSR configuration between AP MLD and STA MLD.

Referring to FIG. 12, a frame including an enhanced multi-link (EML) control field may be transmitted and received in an EMLSR configuration procedure and/or an enhanced multi-link multi-radio (EMLMR) configuration procedure. The EML control field may be included in an EML operating mode notification (OMN) frame. The EMLSR mode field set to 1 may indicate that a STA MLD or STA transmitting the EML control field intends to use EMLSR. When the EMLSR mode field is set to 1, the EML control field (e.g., EML control field format) may include an EMLSR implicit SMPS field. Even when the EMLSR mode field is set to 0, the EML control field may include the EMLSR implicit SMPS field.

The EMLSR implicit SMPS field may include one or more bits. When the EMLSR implicit SMPS field includes 1 bit, the EMLSR implicit SMPS field is set to 1, and the STA MLD or STA transmitting the EML control field can use one of EMLSR links, the STA MLD or STA may implicitly perform an SMPS operation on the available link, as in the exemplary embodiments of FIGS. 8A and/or 8B. The EMLSR implicit SMPS field set to 0 may mean (e.g., indicate) that the STA MLD or STA is not to implicitly perform an SMPS operation on an available link even when one of EMLSR links can be used. Even when the STA MLD or STA performs the EMLMR operation, if the EMLSR implicit SMPS field includes 1 bit, the EMLSR implicit SMPS field is set to 1, and the STA MLD or STA transmitting the EML control field can use one of EMLSR links, the STA MLD or STA may implicitly perform an SMPS operation on the available link as in the exemplary embodiments of FIGS. 8A and/or 8B.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first device, comprising:
receiving, from a second device, a first frame including first information indicating stop of using a first link of a multi-link on the first link; and
performing first communication with the second device on a second link of the multi-link, the second link being a link whose use is not indicated to be stopped by the first frame,
wherein second communication between the first device and the second device is not performed on the first link whose use is indicated to be stopped by the first frame.

2. The method according to claim 1, wherein the first frame further includes second information indicating a time at which use of the first link is stopped, the first communication between the first device and the second device link is performed on the second link from the time, and the first link is not used from the time.

3. The method according to claim 1, wherein the first information is traffic identifier (TID)-to-link mapping information, and there is no TID mapped to the first link in the TID-to-link mapping information.

4. The method according to claim 1, wherein the performing of the first communication with the second device comprises:
receiving a data frame from the second device on the second link without receiving an initial control frame of the second device; and
transmitting a response frame for the data frame to the second device on the second link.

5. The method according to claim 1, wherein when the first device supports an enhanced multi-link single radio (EMLSR) operation, the first link and the second link are EMLSR links, and only one link among the EMLSR links is available according to indication of the first frame, the EMLSR operation of the first device is stopped.

6. The method according to claim 1, wherein the first frame is a beacon frame or an extreme high throughput (EHT) action frame.

7. The method according to claim 1, wherein the first device is a station (STA) multi-link device (MLD), the first device includes a first STA operating on the first link and a second STA operating on the second link, the second device is an access point (AP) MLD, and the second device includes a first AP operating on the first link and a second AP operating on the second link.

8. A method of a first device, comprising:
receiving, from a second device, a first frame including first information indicating stop of using a first link of a multi-link on the first link; and
performing a listening operation on a second link and a third link of the multi-link, the second link and the third link being links whose uses are not indicated to be stopped by the first frame,
wherein communication between the first device and the second device is not performed on the first link whose use is indicated to be stopped by the first frame.

9. The method according to claim 8, wherein the first frame further includes second information indicating a time at which use of the first link is stopped, and the first link is not used from the time.

10. The method according to claim 9, wherein enhanced multi-link single radio (EMLSR) links before the time include the first link, the second link, and the third link, the EMLSR links after the time include the second link and the third link, and the EMLSR links are reconfigured based on the first frame.

11. The method according to claim 8, wherein the first information is traffic identifier (TID)-to-link mapping information, and there is no TID mapped to the first link in the TID-to-link mapping information.

12. The method according to claim 8, further comprising:
receiving an initial control frame from the second device on one link among the second link and the third link; and
after receiving the initial control frame, receiving a data frame from the second device on the one link.

13. The method according to claim 8, wherein the first device is a station (STA) multi-link device (MLD), the first device includes a first STA operating on the first link, a second STA operating on the second link, and a third STA operating on the third link, the second device is an access point (AP) MLD, and the second device includes a first AP operating on the first link, a second AP operating on the second link, and a third AP operating on the third link.

14. A method of a second device, comprising:
generating a first frame including first information indicating stop of using a first link of a multi-link;
transmitting the first frame to a first device on the first link; and
performing first communication with the first device on a second link of the multi-link, the second link being a link whose use is not indicated to be stopped by the first frame,
wherein second communication between the first device and the second device is not performed on the first link whose use is indicated to be stopped by the first frame.

15. The method according to claim 14, wherein the performing of the first communication with the first device comprises, when the second device does not perform an enhanced multi-link single radio (EMLSR) operation, transmitting a data frame to the first device without transmitting an initial control frame on the second link.

16. The method according to claim 14, wherein the performing of the first communication with the first device comprises:
when the second device performs an EMLSR operation, transmitting an initial control frame to the first device on the second link; and
after transmitting the initial control frame, transmitting a data frame to the first device on the second link.

17. The method according to claim 14, wherein the first information is traffic identifier (TID)-to-link mapping information, and there is no TID mapped to the first link in the TID-to-link mapping information.

18. The method according to claim 14, wherein when the first device supports an enhanced multi-link single radio (EMLSR) operation, the first link and the second link are EMLSR links, and only one link among the EMLSR links is available according to indication of the first frame, the EMLSR operation of the first device is stopped.

19. The method according to claim 14, wherein the first frame further includes second information indicating a time at which use of the first link is stopped, and the first link is not used from the time.

20. The method according to claim 19, wherein enhanced multi-link single radio (EMLSR) links before the time include the first link, the second link, and the third link, the EMLSR links after the time include the second link and the third link, and the EMLSR links are reconfigured based on the first frame.
